(19) United States
(12) Patent Application Publication
(10) Pub. No.: US 2016/0259894 A1
(43) Pub. Date: Sep. 8, 2016

(54) Method and System for Matching Providers in the Medical and Pharmaceutical Field

(71) Applicant: Med Invest Holding B.V., Nieuwegein (NL)

(72) Inventors: Heinrich HANDEL-MAZZETTI, Nieuwegein (NL); Esther van der GRAAF, Nieuwegein (NL)

(21) Appl. No.: 14/640,262

(22) Filed: Mar. 6, 2015

(51) Int. Cl. G06F 19/00

(52) U.S. Cl. CPC G06F 19/327

(57) ABSTRACT

In a computer-implemented method and system for matching, in the medical or pharmaceutical field, a first provider with a second provider, the first provider provides at least one first type indicator, first location indicator, first field indicator, first category indicator, and first sub-category indicator, together characterizing the first provider, and at least one of a third type indicator, third location indicator, third field indicator, third category indicator, and third sub-category indicator, characterizing an envisaged provider. The second provider provides at least one second type indicator, second location indicator, second field indicator, second category indicator, and second sub-category indicator, together characterizing the second provider. The received second and third type indicators, received second and third location indicators, received second and third field indicators, and received second and third category indicators are compared with each other. If a match of at least one specific one of the received second and third type indicators, received second and third location indicators, received second and third field indicators, and received second and third category indicators is found, then corresponding messages are sent to the first and second provider, and matching information is stored.

### FIELD OF THE INVENTION

The invention relates to the field of matching, and more specifically to a computer-implemented method and system for matching, in the medical or pharmaceutical field, a first provider with a second provider.

### BACKGROUND OF THE INVENTION

In the medical and pharmaceutical field, many parties operate to provide one or more specific products, services, intellectual property, money, etc. Herein, these parties are generally indicated as providers. The providers, each from their respective role and goals, try to come into contact with other providers for purposes of developing their businesses. Information about providers generally can be found from various sources, for example in printed or in digital form, through books, guides (for example, the so-called Yellow Pages) leaflets, brochures, websites run by a provider, websites offering aggregated information on several providers, etc.

For one provider trying to identify one or more other providers for business development, it has remained a tedious task to find appropriate business partners. Often a great deal of time, effort and money is spent by a first provider before discovering that another provider, being an envisaged business partner, in fact does not fit the criteria set by the first provider.

Therefore, a need exists to provide an efficient and convenient way for providers in the medical and pharmaceutical field to establish business contacts with each other.

### SUMMARY OF THE INVENTION

It would be desirable to provide a method and system enabling a provider to find another provider that would be able to fulfill its business needs. It would also be desirable to provide a method and system enabling a provider to be found by another provider to possibly fulfill the other provider's business needs.

To better address one or more of these concerns, in a first aspect of the invention a computer-implemented method is provided for matching, in the medical or pharmaceutical field, a first provider with a second provider. The first provider and the second provider are physical and/or legal entities in the medical and/or pharmaceutical field, such as manufacturing companies or manufacturers, distributing companies or distributors, IP (intellectual property) owning companies or IP owners, research companies or researchers, investment companies or investors, etc. The method comprises the following steps performed by a computer or computer system, hereinafter briefly referred to as a computer. The computer comprises at least one memory and processor.

The computer registers contact data of the first provider and the second provider, wherein the contact data are inputted into the computer by the first provider and the second provider. The computer receives, from the first provider, at least one first type indicator, at least one first location indicator, at least one first field indicator, at least one first category indicator, and at least one first sub-category indicator, wherein the first type indicator, first location indicator, first field indicator, first category indicator, and first sub-category indicator characterize the first provider. The computer receives, from the second provider, at least one second type indicator, at least one second location indicator, at least one second field indicator, at least one second category indicator, and at least second sub-category indicator, wherein the second type indicator, second location indicator, second field indicator, second category indicator, and second sub-category indicator characterize the second provider. The computer receives, from the first provider, at least one of a third type indicator, third location indicator, third field indicator, third category indicator, and third sub-category indicator, wherein the at least one of the third category indicator, third location indicator, third field indicator, third category indicator, and third sub-category indicator characterizes an envisaged provider different from the first provider. The computer stores the received first, second, and third type indicators, first, second, and third location indicators, first, second, and third field indicators, first, second, and third category indicators, and first, second, and third sub-category indicators. The computer compares the received second and third type indicators with each other, the received second and third location indicators with each other, the received second and third field indicators with each other, and the received second and third category indicators with each other. If a match of at least one specific one of the received second and third type indicators, at least one specific one of the received second and third location indicators, at least one specific one of the received second and third field indicators, and at least one specific one of the received second and third category indicators is found, then the computer generates a first message indicating the match, and including contact data of the second provider, and sends the first message to the first provider. In case of the match, the computer also generates a second message indicating the match, and including contact data of the first provider, and sends the second message to the second provider. The computer stores matching information including the at least one specific one of the received second and third type indicators, the at least one specific one of the received second and third location indicators, the at least one specific one of the received second and third field indicators, and the at least one specific one of the received second and third category indicators.

With the computer-implemented method of the present invention, a first medical and/or pharmaceutical provider and a second medical and/or pharmaceutical provider can identify and locate reliable business partners to fulfill their needs. Matching their mutual demands allows them to expand their product ranges and markets in a particular region or even worldwide. Suitable business partners are located by searching on the platform provided by the computer, through an automated matching component which will send first and second messages when identifying a potential match. Receiving an alerting second message makes finding new business partners a simple process, without incurring major costs.

In an embodiment of the computer-implemented method, the computer further compares the received second and third sub-category indicators with each other, and if a match of at least one specific one of the received second and third type indicators, at least one specific one of the received second and third location indicators, at least one specific one of the received second and third field indicators, at least one specific one of the received second and third category indicators, and at least one specific one of the received second and third sub-category indicators is found, then the computer further stores the at least one specific one of the received second and third sub-category indicators in the matching information.

In an embodiment of the computer-implemented method, at least one of the first message and the second message further includes at least part of the matching information.

In an embodiment of the computer-implemented method, if the match is found, the computer further includes at least part of the contact data of the second provider in a first listing accessible for the first provider, and includes at least part of the contact data of the first provider in a second listing accessible for the second provider.

In an embodiment of the computer-implemented method, if the match is found, the computer further includes at least part of the matching information in at least one of the first listing and the second listing.

In an embodiment of the computer-implemented method, the first, second and third type indicators each represent at least one of a manufacturing type, a distributing type, a patenting type, a researching type, and an investing type.

In an embodiment of the computer-implemented method, the first, second and third field indicators each represent at least one of a medical devices for human applications category, a pharmaceutical for human applications category, a medical devices for veterinary applications category, and a pharmaceutical for veterinary applications category.

In an embodiment of the computer-implemented method, the first location indicator represents at least one location of the first provider, the second location indicator represents at least one location of the second provider, and the third location indicator represents at least one location of the envisaged provider.

In an embodiment of the computer-implemented method, the first, second and third category indicators, and the first, second and third sub-category indicators each comprise a classification according to any of the Universal Medical Device Nomenclature System, UMDNS, the Anatomical Therapeutic Chemical classification system, ATC, and the ATC for veterinary products, ATC Vet.

In an embodiment of the computer-implemented method, the first, second and third category indicators each represent at least one medical device type, if the corresponding first, second and third field indicators represent a medical devices for human applications category or a medical devices for veterinary application category.

In an embodiment of the computer-implemented method, the first, second and third sub-category indicators each represent at least one medical device, if the corresponding first, second and third field indicators represent a medical devices for human applications category or a medical devices for veterinary application category.

In an embodiment of the computer-implemented method, the first, second and third category indicators represent a pharmaceutical application, if the corresponding first, second and third field indicators represent a pharmaceutical for human applications category or a pharmaceutical for veterinary applications category.

In an embodiment of the computer-implemented method, the first, second and third sub-category indicators represent a pharmaceutical product, if the corresponding first, second and third field indicators represent a pharmaceutical for human applications category or a pharmaceutical for veterinary applications category.

In an embodiment of the computer-implemented method, the computer performs the comparing step repeatedly. In a further embodiment, if the match is found a further time, while the received first, second, and third type indicators, the received first, second, and third location indicators, the received first, second, and third field indicators, the received first, second, and third category indicators, and the received first, second, and third sub-category indicators remain unchanged, then the computer does not send the first message and the second message anew. In another embodiment of the computer-implemented method, if the match is found a further time, while at least one of the received first, second, and third type indicators, the received first, second, and third location indicators, the received first, second, and third field indicators, the received first, second, and third category indicators, and the received first, second, and third sub-category indicators has been received anew and updated, the computer sends the first message and the second message anew.

In an embodiment of the computer-implemented method, for each provider, the field indicator hierarchically is under the type indicator, the category indicator hierarchically is under the field indicator, and the sub-category indicator hierarchically is under the category indicator.

In a second aspect of the invention, a system is provided for matching, in the medical or pharmaceutical field, a first provider with a second provider. The system comprises a memory configured to store computer instructions; and a computer comprising a processor configured to execute said computer instructions. The computer instructions are for registering contact data of the first provider and the second provider. The computer instructions also are for receiving, from the first provider, at least one first type indicator, at least one first location indicator, at least one first field indicator, at least one first category indicator, and at least one first sub-category indicator, wherein the first type indicator, first location indicator, first field indicator, first category indicator, and first sub-category indicator characterize the first provider. The computer instructions also are for receiving, from the second provider, at least one second type indicator, at least one second location indicator, at least one second field indicator, at least one second category indicator, and at least second sub-category indicator, wherein the second type indicator, second location indicator, second field indicator, second category indicator, and second sub-category indicator characterize the second provider. The computer also are for receiving, from the first provider, at least one of a third type indicator, third location indicator, third field indicator, third category indicator, and third sub-category indicator, wherein the at least one of the third category indicator, third location indicator, third field indicator, third category indicator, and third sub-category indicator characterizes an envisaged provider different from the first provider. The computer instructions also are for storing the received first, second, and third type indicators, first, second, and third location indicators, first, second, and third field indicators, first, second, and third category indicators, the first, second, and third sub-category indicators. The computer instructions also are for comparing the received second and third type indicators with each other, the received second and third location indicators with each other, the received second and third field indicators with each other, and the received second and third category indicators with each other. If a match of at least one specific one of the received second and third type indicators, at least one specific one of the received second and third location indicators, at least one specific one of the received second and third field indicators, and at least one specific one of the received second and third category indicators is found, then the computer instructions also are for generating a first message indicating the match, and including contact data of the second provider, and sending the first message to the first provider, and for generating a second message indicating the match, and including contact data of the first provider, and sending the second message to the second provider. The computer instructions also are for storing matching information including the at least one specific one of the received second and third type indicators, the at least one specific one of the received second and third location indicators, the at least one specific one of the received second and third field indicators, and the at least one specific one of the received second and third category indicators.

In a third aspect of the present invention, a non-volatile data carrier product is provided, the data carrier product storing computer instructions for a computer to execute said computer instructions for matching, in the medical or pharmaceutical field, a first provider with a second provider.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 depicts a schematic block diagram of a system for matching a first provider with a second provider according to the present invention.

FIGS. 2A and 2B depict flow diagrams of an embodiment of a method for matching a first provider with a second provider according to the present invention.

FIGS. 3A and 3B illustrate hierarchical data models for a provider and an envisaged provider, respectively.

FIG. 4 illustrates a web page for inputting provider indicator data.

### DETAILED DESCRIPTION OF EMBODIMENTS

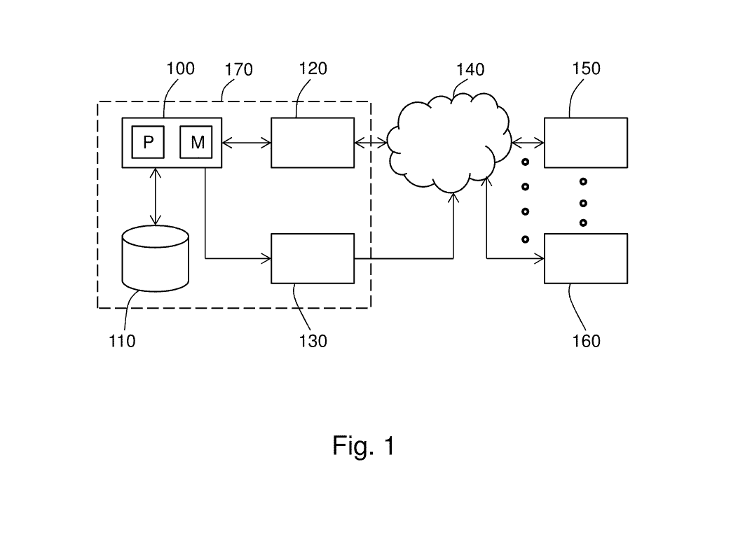

FIG. 1 depicts a schematic block diagram of a system for matching, in the medical and/or pharmaceutical field, a first provider with a second provider. The system is a computer-implemented system comprising several data-processing devices being in data communication with each other.

The system comprises a main server 100 operatively coupled to a database device 110, a web application server 120, and a mail server 130. The web application server 120 and the mail server 130 are operatively coupled to a network 140 enabling data communication with a plurality of provider computers, a first provider computer 150, and a second provider computer 160. For explanation of the present invention, only two provider computers 150, 160 are shown, however, as illustrated by dotted lines, the system may accommodate a plurality of provider computers, i.e. considerably more than two. The main server 100, database device 110, web application server 120 and mail server together constitute a matching system 170, as indicated by a dashed line.

Network 140 allows the provider computers 150, 160 to communicate with the main server 100 through the web application server 120. The network 140 may be a shared, public, or private network. Network 140 may encompass a wide area or local area. Network 140 may be implemented through any suitable combination of wired and/or wireless communication networks. Network 140 may comprise an intranet or the Internet.

The main server 100 may comprise a general purpose computer, such as a personal computer, a network computer, or a mainframe computer, having one or more processors P that may be activated or reconfigured by a computer program. One or more of the processors may execute computer instructions consistent with embodiments of the computer-implemented method disclosed herein by reading the computer instructions from a memory M, and executing them.

The memory M may be one or more memory or storage devices or data carrier products configured to store data and software, wherein the software comprises computer instructions for the one or more processors of the main server 100 to carry out embodiments of the method of the present invention. Memory M may comprise, for example, one or more of RAM, ROM, magnetic storage or optical storage media. In other embodiments, main server 100 may be specially constructed for carrying out embodiments of the method of the present invention. For example, one or more of the steps, as disclosed herein and carried out by the main server 100, may be implemented on a field-programmable gate array, FPGA, an application-specific integrated circuit, ASIC, or another suitable chipset.

Database device 110 may comprise a query engine, such as a MySQL query engine, receiving queries from the main server 100 or the provider terminals 150, 160, and retrieving data stored in the database device 110. In an alternative embodiment, the database device 110 may be implemented on a computer, accessible by the main server 100 over a network such as network 140.

Provider terminals 150, 160 may be similar in construction to main server 100. The provider terminals may comprise one or more processors, and a memory. The provider terminals 150, 160 further each include a web browser to display, and interact with, web pages provided by the web application server 120.

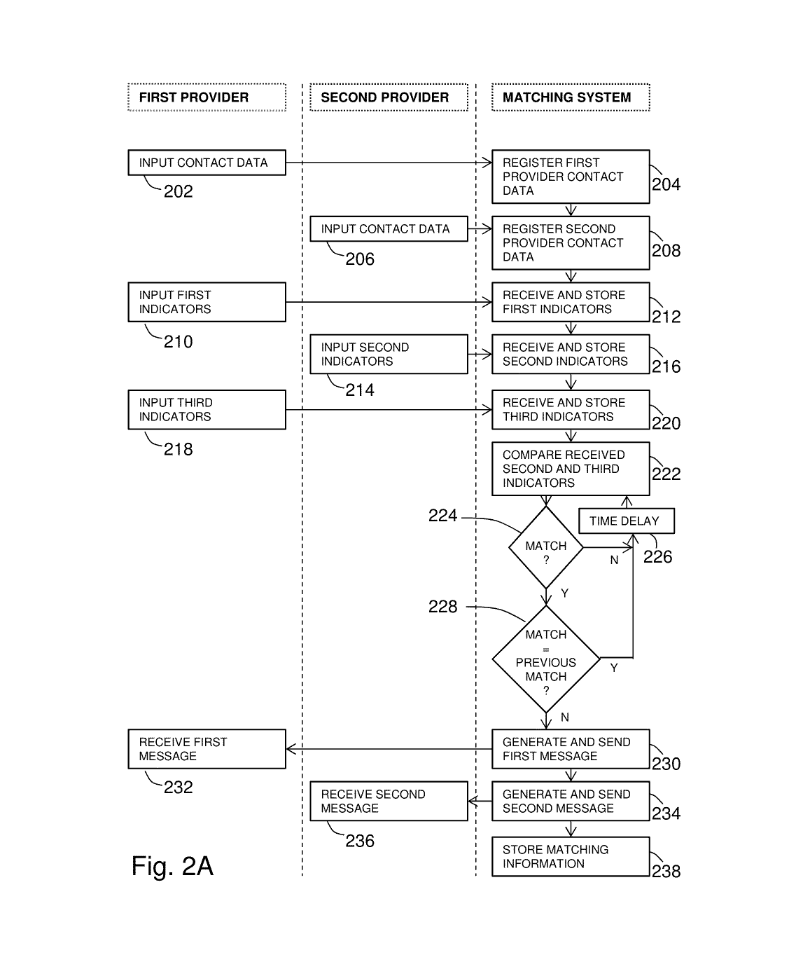

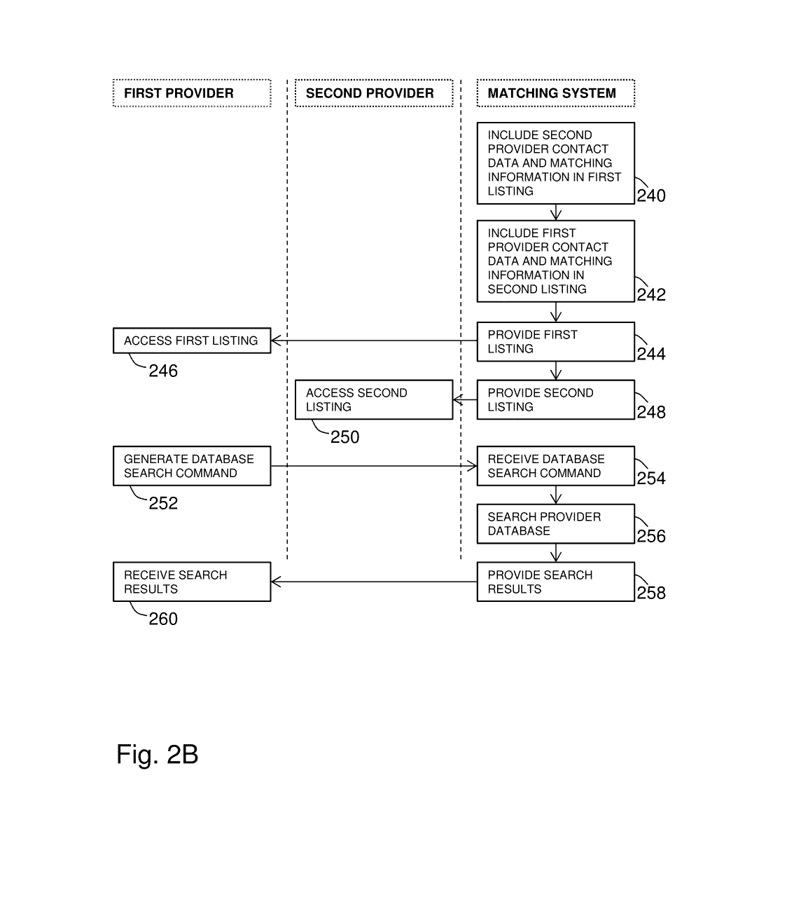

FIGS. 2A and 2B depict flow diagrams of embodiments of a method for matching a first provider with a second provider according to the present invention. In FIGS. 2A, 2B, method steps taken by different entities “first provider”, “second provider” and “matching system” (as shown in dotted boxes) are illustrated. It is to be understood that such entities in fact are computers controlled by associated software, where the first provider computer 150 is further controlled by a user associated with the first provider, and where the second provider computer 160 is further controlled by a user associated with the second provider. The matching system computer or computers are illustrated in FIG. 1, indicated by matching system 170.

According to a step 202, a first provider, through first provider computer 150, inputs corresponding contact data into a web page provided by web application server 120.

According to step 204, the matching system 170 receives and registers the contact data of the first provider in the database device 110. The first provider contact data, which may also be referred to as the first provider contact profile, may comprise name and address details, communication details such as contact person(s), telephone number(s), fax number(s), e-mail address(es), website URL and any other contact data that may be useful.

According to step 206, a second provider, through second provider computer 160, inputs corresponding contact data into a web page provided by web application server 120. For the second provider, the same kind of contact data are requested as for the first provider.

It is noted here, that for an explanation of the method and system of the present invention, only reference is made to a first provider and a second provider, and their interaction. However, in practice, many more providers may be involved in the method and system, which method and system accommodate an easy, efficient and accurate matchmaking process between a plurality of providers.

According to step 208, the matching system 170 receives and registers the contact data of the second provider in the database device 110.

Furthermore, each of the first provider and the second provider, and any further providers, are requested to input, on a dedicated web page to be filled out mandatorily, specific indicators defining their business type, the specific medical and/or pharmaceutical field, their physical location, the category of their products and/or services, and sub-category of products and/or services.

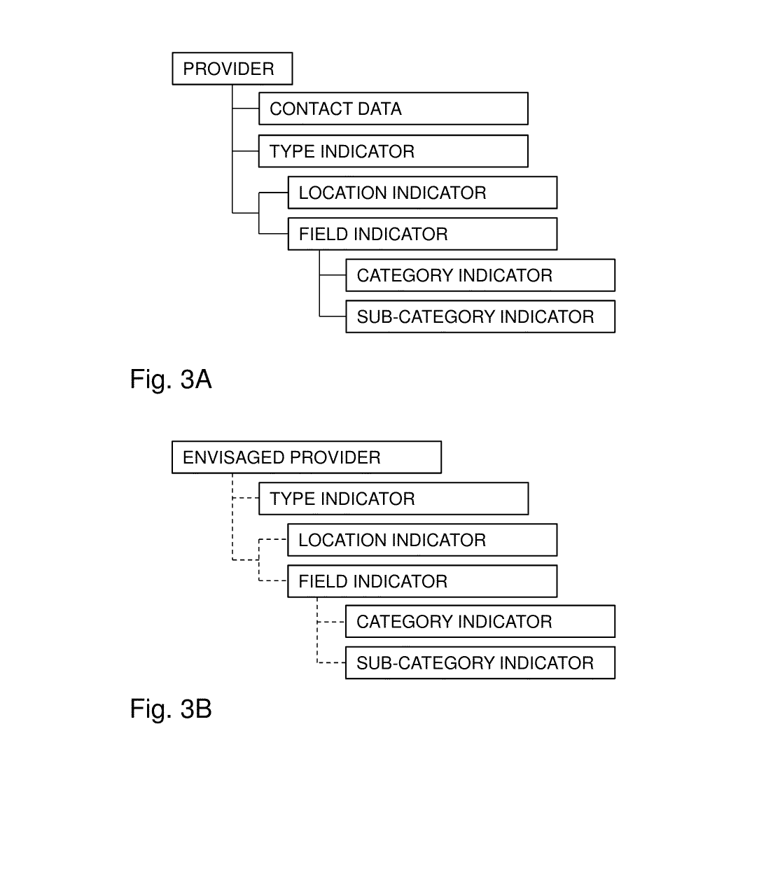

As illustrated in FIG. 3A, for each provider a type indicator, a field indicator, a location indicator, a category indicator, and a sub-category indicator are requested. A type indicator represent at least one of a manufacturing type, a distributing type, a patenting type, a researching type, and an investing type. A field indicator represent at least one of a medical devices for human applications category, a pharmaceutical for human applications category, a medical devices for veterinary applications category, and a pharmaceutical for veterinary applications category. A location indicator may represent the world, a region or continent thereof, a country, a country region, or any other physical location where the provider is established or markets its products and/or services in the specified field. The field indicator and location indicator are hierarchically dependent on the type indicator, as illustrated in FIG. 3A.

A category indicator represents at least one medical device type, if the corresponding field indicator represents a medical devices for human applications category or a medical devices for veterinary application category. A sub-category indicator represents at least one medical device, if the corresponding field indicator represents a medical devices for human applications category or a medical devices for veterinary application category. A category indicator represents at least one pharmaceutical application, if the corresponding field indicator represents a pharmaceutical for human applications category or a pharmaceutical for veterinary applications category. A sub-category indicator represents a pharmaceutical product, if the corresponding field indicator represents a pharmaceutical for human applications category or a pharmaceutical for veterinary applications category. The category indicator is hierarchically dependent on the field indicator, and the sub-category indicator is directly hierarchically dependent on the category indicator, and indirectly hierarchically dependent on the field indicator. The category indicator and the sub-category indicator each comprise a classification according to any of the Universal Medical Device Nomenclature System, UMDNS, the Anatomical Therapeutic Chemical classification system, ATC, and the ATC for veterinary products, ATC Vet.

According to step 210, the first provider, through first provider computer 150, inputs at least one first type indicator, at least one first location indicator, at least one first field indicator, at least one first category indicator, and at least one first sub-category indicator in one or more web pages provided by web application server 120. The first type indicator, first location indicator, first field indicator, first category indicator, and first sub-category indicator characterize the first provider.

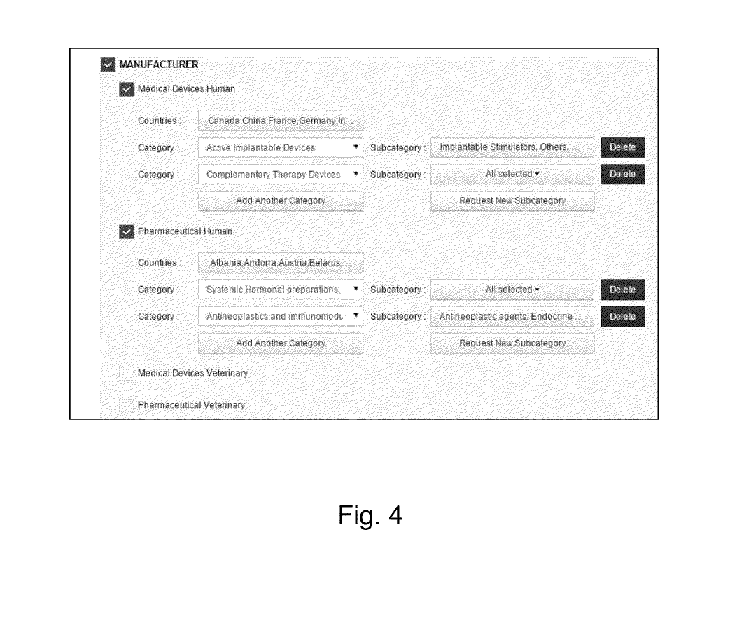

The web page may provide input fields as illustrated in FIG. 4. In the example of FIG. 4, the first provider already inputted on another part (not shown) of the web page, or on a preceding web page, a type indicator, being “manufacturer”. On the illustrated web page, the first provider has indicated, by checking appropriate boxes, a field indicator representing the medical devices for human applications category, and a field indicator representing the pharmaceutical for human applications category. Within the medical devices for human applications category, a location indicator indicates: Canada, China, France, Germany and other locations, wherein the category indicator indicates: Active Implantable Devices, with a sub-category indicator indicating: Implantable Stimulators, Others. Also, within the medical devices for human applications category, a location indicator indicates: Canada, China, France, Germany and other locations, wherein the category indicator indicates: Complementary Therapy Devices, with no specific sub-category indicator selected. Within the pharmaceutical for human applications category, a location indicator indicates: Albania, Andorra, Austria, Belarus and other locations, wherein the category indicator indicates: Systemic Hormonal preparations, with a sub-category indicator indicating no specific sub-category selected. Also, within the pharmaceutical for human applications category, a location indicator indicates: Albania, Andorra, Austria, Belarus and other locations, wherein the category indicator indicates: Antineoplastics and immunomodu, with a subcategory indicator indicating: Antineoplastic agents, Edocrine.

Returning to FIG. 2A, according to step 212, the matching system 170 receives the at least one first type indicator, at least one first location indicator, at least one first field indicator, at least one first category indicator, and at least one first sub-category indicator input by the first provider through the first provider computer 150, and stores these various first indicators in the database device 110.

According to step 214, the second provider inputs, through second provider computer 160, at least one second type indicator, at least one second location indicator, at least one second field indicator, at least one second category indicator, and at least second sub-category indicator in one or more web pages provided by web application server 120. The second type indicator, second location indicator, second field indicator, second category indicator, and second sub-category indicator characterize the second provider. Just like for the first provider, the web page may provide input fields as illustrated in FIG. 4 for the second provider.

According to step 216, the matching system 170 receives the at least one second type indicator, at least one second location indicator, at least one second field indicator, at least one second category indicator, and at least second sub-category indicator input by the second provider through the second provider computer 160, and stores these various second indicators in the database device 110.

The first provider and the second provider, and any further provider, after having the matching system 170 receive and register their contact data and indicator data, and consenting to terms of use, have access to the matchmaking functionality of the matching system, explained as follows for the first provider seeking to come into contact with a second provider, yet unknown for the first provider.

According to step 218, the first provider inputs, through first provider computer 150 at least one of a third type indicator, third location indicator, third field indicator, third category indicator, and third sub-category indicator in one or more web pages provided by web application server 120. The at least one of the third category indicator, third location indicator, third field indicator, third category indicator, and third sub-category indicator characterizes an envisaged provider different from the first provider.

It is noted here that for a matching result which is as accurate as possible, the first provider preferably inputs as many of the third type indicator, third location indicator, third field indicator, third category indicator and third sub-category indicator as possible. From the hierarchical structure of these indicators, as explained above, and indicated in FIG. 3B, it will be clear that choosing e.g. a specific sub-category indicator also entails choosing a specific type indicator, field indicator, and category indicator. On the other hand, merely selecting a type indicator, or a type indicator and a field indicator, may render a search for a matching second provider impractical, because it provides too many results. In FIG. 3B, dashed lines have been used to indicate that the possibility of not using all third indicators exists.

According to step 220, the matching system 170 receives the at least one of a third type indicator, third location indicator, third field indicator, third category indicator, and third sub-category indicator input by the first provider through first provider computer 150, and stores these various third indicators in the database device 110.

According to step 222, the matching system 170 compares the received second and third type indicators with each other, the received second and third location indicators with each other, the received second and third field indicators with each other, and the received second and third category indicators with each other, and optionally also the received second and third sub-category indicators with each other.

According to step 224, the matching system 170 determines whether a match of at least one specific one of the received second and third type indicators, at least one specific one of the received second and third field indicators, at least one specific one of the received second and third location indicators, and at least one specific one of the received second and third category indicators is found, or not. If no match is found (indication “N”) then according to step 226 after a time delay step 222 is repeated. On the other hand, if a match is found (indication “Y”) then according to step 228 it is determined whether such a match was found previously, determinable by virtue of step 238, to be discussed below. If such match was found previously (indication “Y”), then according to step 226 after a time delay step 222 is repeated. On the other hand, if such match was not found previously (indication “N”) then the process flow continues at step 230.

According to step 230, and based on the situation that a match has been found the first time, the matching system 170 generates a first message indicating the match, and including at least some or all of the contact data and the second data of the second provider, and sends the first message to the first provider computer 150, or any other communication device associated with the first provider, through the mail server 130. The first message may indicate the match by providing matching information including the at least one specific one of the received second and third type indicators, the at least one specific one of the received second and third field indicators, the at least one specific one of the received second and third location indicators, and the at least one specific one of the received second and third category indicators.

According to step 232, the first provider, through first provider computer 150 or other communication device, receives the first message from the mail server 130.

Also, according to step 234, and based on the situation that a match has been found the first time, the matching system 170 generates a second message indicating the match, and including at least some or all of the contact data and first indicators of the first provider, and sends the second message to the second provider computer 160, or any other communication device associated with the second provider, through the mail server 130. The second message may indicate the match by providing matching information including the at least one specific one of the received second and third type indicators, the at least one specific one of the received second and third field indicators, the at least one specific one of the received second and third location indicators, and the at least one specific one of the received second and third category indicators.

According to step 236, the second provider, through second provider computer 160 or other communication device, receives the second message from the mail server 130.

The time delay of step 22 is introduced to prevent providers from receiving too many messages within a certain time period of, for example, a day, which would otherwise result from continuous updates of provider's details in the matching system 170.

According to step 238, the matching system stores matching information including the at least one specific one of the received second and third type indicators, the at least one specific one of the received second and third field indicators, the at least one specific one of the received second and third location indicators, and the at least one specific one of the received second and third category indicators in the database device 110. The matching information is in particular used in step 228 to determine whether a specific match was found previously, or not.

According to step 240, the matching system 170, if a match is found, includes at least part of the contact data of the second provider in a first listing accessible for the first provider through the first provider computer 150. The first listing further may include at least part of the matching information.

Also, according to step 242, the matching system 170, if a match is found, includes at least part of the contact data of the first provider in a second listing accessible for the second provider through the second provider computer 160. The second listing further may include at least part of the matching information.

According to step 244, the matching system 170 provides the first listing to the first provider through the first provider computer 150.

According to step 246, the first provider, through the first provider computer 150, accesses the first listing.

According to step 248, the matching system 170 provides the second listing to the second provider through the second provider computer 160.

According to step 250, the second provider, through the second provider computer 160, accesses the second listing.

According to step 252, the first provider or the second provider, through respective first provider computer 150 and second provider computer 160, generates a database search command in a web page provided by web application server 120.

At any time, a provider may, through its provider computer, search the matching system 170 for a matching other provider. Similar possibilities as explained in relation to step 218 are provided, however, without storing the search criteria.

According to step 254, the matching system 170, in particular the main server 100, receives the database search command from the web application server 120.

According to step 256, the matching system 170 searches the database device 110 based on the database search command received from the first or second provider.

According to step 258, the matching system 170 provides search results, in particular in a web page through web application server 120, to the first or second provider through the respective first provider computer 150 and second provider computer 160.

According to step 260, the first of second provider, through respective first provider computer 150 and second provider computer 160, receives the search results available in a web page through web application server 120.

As explained in detail above, in a computer-implemented method and system for matching, in the medical or pharmaceutical field, a first provider with a second provider, the first provider provides at least one first type indicator, first location indicator, first field indicator, first category indicator, and first sub-category indicator, together characterizing the first provider, and at least one of a third type indicator, third location indicator, third field indicator, third category indicator, and third sub-category indicator, characterizing an envisaged provider. The second provider provides at least one second type indicator, second location indicator, second field indicator, second category indicator, and second sub-category indicator, together characterizing the second provider. The received second and third type indicators, received second and third field indicators, received second and third location indicators, and received second and third category indicators are compared with each other. If a match of at least one specific one of the received second and third type indicators, received second and third location indicators, received second and third field indicators, and received second and third category indicators is found, then corresponding messages are sent to the first and second provider, and matching information is stored.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

The term coupled, as used herein, is defined as connected, although not necessarily directly, and not necessarily mechanically.

A single processor or other unit may fulfil the functions of several items recited in the claims.

The terms computer program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

A computer program may be stored and/or distributed on a suitable medium, such as an optical storage medium or a solid-state medium supplied together with or as part of other hardware, but also be distributed in other forms, such as via the Internet or other wired or wireless telecommunication systems.

1. A computer-implemented method for matching a first provider with a second provider, the method comprising the following steps performed by a computer:
registering contact data of the first provider and the second provider;
receiving, from the first provider, at least one first type indicator, at least one first location indicator, at least one first field indicator, at least one first category indicator, and at least one first sub-category indicator, wherein the first type indicator, first location indicator, first field indicator, first category indicator, and first sub-category indicator characterize the first provider;
receiving, from the second provider, at least one second type indicator, at least one second location indicator, at least one second field indicator, at least one second category indicator, and at least second sub-category indicator, wherein the second type indicator, second location indicator, second field indicator, second category indicator, and second sub-category indicator characterize the second provider;
receiving, from the first provider, at least one of a third type indicator, third location indicator, third field indicator, third category indicator, and third sub-category indicator, wherein the at least one of the third category indicator, third location indicator, third field indicator, third category indicator, and third sub-category indicator characterizes an envisaged provider different from the first provider;
storing the received first, second, and third field indicators, first, second, and third type indicators, first, second, and third location indicators, first, second, and third category indicators, and first, second, and third sub-category indicators; and
comparing the received second and third type indicators with each other, the received second and third location indicators with each other, the received second and third field indicators with each other, and the received second and third category indicators with each other, and if a match of at least one specific one of the received second and third type indicators, at least one specific one of the received second and third location indicators, at least one specific one of the received second and third field indicators, and at least one specific one of the received second and third category indicators is found, then:
generating a first message indicating the match, and including contact data of the second provider;
sending the first message to the first provider;
generating a second message indicating the match, and including contact data of the first provider;
sending the second message to the second provider; and
storing matching information including the at least one specific one of the received second and third type indicators, the at least one specific one of the received second and third location indicators, the at least one specific one of the received second and third field indicators, and the at least one specific one of the received second and third category indicators.

2. The computer-implemented method according to claim 1, further comprising the steps of:
comparing the received second and third sub-category indicators with each other, and if a match of at least one specific one of the received second and third type indicators, at least one specific one of the received second and third location indicators, at least one specific one of the received second and third field indicators, at least one specific one of the received second and third category indicators, and at least one specific one of the received second and third sub-category indicators is found, then further storing the at least one specific one of the received second and third sub-category indicators in the matching information.

3. The computer-implemented method according to claim 1, wherein at least one of the first message and the second message further includes at least part of the matching information.

4. The computer-implemented method according to claim 1, further comprising, if the match is found, the steps of:
including at least part of the contact data of the second provider in a first listing accessible for the first provider; and
including at least part of the contact data of the first provider in a second listing accessible for the second provider.

5. The computer-implemented method according to claim 3, further comprising, if the match is found, the steps of:
including at least part of the matching information in at least one of the first listing and the second listing.

6. The computer-implemented method according to claim 1, wherein the first, second and third type indicators each represent at least one of a manufacturing type, a distributing type, a patenting type, a researching type, and an investing type.

7. The computer-implemented method according to claim 1, wherein the first provider and the second provider are in a medical or pharmaceutical field, and wherein the first, second and third field indicators each represent at least one of a medical devices for human applications category, a pharmaceutical for human applications category, a medical devices for veterinary applications category, and a pharmaceutical for veterinary applications category.

8. The computer-implemented method according to claim 1, wherein the first location indicator represents at least one location of the first provider, the second location indicator represents at least one location of the second provider, and the third location indicator represents at least one location of the envisaged provider.

9. The computer-implemented method according to claim 1, wherein the first provider and the second provider are in a medical or pharmaceutical field, and wherein the first, second and third category indicators, and the first, second and third sub-category indicators each comprise a classification according to any of the Universal Medical Device Nomenclature System, UMDNS, the Anatomical Therapeutic Chemical classification system, ATC, and the ATC for veterinary products, ATC Vet.

10. The computer-implemented method according to claim 1, wherein the first provider and the second provider are in a medical or pharmaceutical field, and wherein the first, second and third category indicators each represent at least one medical device type, if the corresponding first, second and third field indicators represent a medical devices for human applications category or a medical devices for veterinary application category.

11. The computer-implemented method according to claim 1, wherein the first provider and the second provider are in a medical or pharmaceutical field, and wherein the first, second and third sub-category indicators each represent at least one medical device, if the corresponding first, second and third field indicators represent a medical devices for human applications category or a medical devices for veterinary application category.

12. The computer-implemented method according to claim 1, wherein the first provider and the second provider are in a medical or pharmaceutical field, and wherein the first, second and third category indicators represent a pharmaceutical application, if the corresponding first, second and third field indicators represent a pharmaceutical for human applications category or a pharmaceutical for veterinary applications category.

13. The computer-implemented method according to claim 1, wherein the first provider and the second provider are in a medical or pharmaceutical field, and wherein the first, second and third sub-category indicators represent a pharmaceutical product, if the corresponding first, second and third field indicators represent a pharmaceutical for human applications category or a pharmaceutical for veterinary applications category.

14. The computer-implemented method according to claim 1, wherein the comparing step is repeatedly performed.

15. The computer-implemented method according to claim 14, wherein, if the match is found a further time, while the received first, second, and third type indicators, the received first, second, and third location indicators, the received first, second, and third field indicators, the received first, second, and third category indicators, and the received first, second, and third sub-category indicators remain unchanged, then the first message and the second message are not sent anew.

16. The computer-implemented method according to claim 14, wherein, if the match is found a further time, while at least one of the received first, second, and third type indicators, the received first, second, and third location indicators, the received first, second, and third field indicators, the received first, second, and third category indicators, and the received first, second, and third sub-category indicators has been received anew and updated, the first message and the second message are sent anew.

17. The computer-implemented method according to claim 1, wherein, for each provider, the field indicator hierarchically is under the type indicator, the category indicator hierarchically is under the field indicator, and the sub-category indicator hierarchically is under the category indicator.

18. A system for matching a first provider with a second provider, the system comprising:
a memory configured to store computer instructions; and
a computer configured to execute said computer instructions for:
registering contact data of the first provider and the second provider;
receiving, from the first provider, at least one first type indicator, at least one first location indicator, at least one first field indicator, at least one first category indicator, and at least one first sub-category indicator, wherein the first type indicator, first location indicator, first field indicator, first category indicator, and first sub-category indicator characterize the first provider;
receiving, from the second provider, at least one second type indicator, at least one second location indicator, at least one second field indicator, at least one second category indicator, and at least second sub-category indicator, wherein the second type indicator, second location indicator, second field indicator, second category indicator, and second sub-category indicator characterize the second provider;
receiving, from the first provider, at least one of a third type indicator, third location indicator, third field indicator, third category indicator, and third sub-category indicator, wherein the at least one of the third category indicator, third location indicator, third field indicator, third category indicator, and third sub-category indicator characterizes an envisaged provider different from the first provider;
storing the received first, second, and third type indicators, first, second, and third location indicators, first, second, and third field indicators, first, second, and third category indicators, the first, second, and third sub-category indicators; and
comparing the received second and third type indicators with each other, the received second and third location indicators with each other, the received second and third field indicators with each other, and the received second and third category indicators with each other, and if a match of at least one specific one of the received second and third type indicators, at least one specific one of the received second and third location indicators, at least one specific one of the received second and third field indicators, and at least one specific one of the received second and third category indicators is found, then:
generating a first message indicating the match, and including contact data of the second provider;
sending the first message to the first provider;
generating a second message indicating the match, and including contact data of the first provider;
sending the second message to the second provider; and
storing matching information including the at least one specific one of the received second and third type indicators, the at least one specific one of the received second and third location indicators, the at least one specific one of the received second and third field indicators, and the at least one specific one of the received second and third category indicators.

19. A non-volatile data carrier product storing computer instructions for a computer to execute said computer instructions for matching a first provider with a second provider by:
registering contact data of the first provider and the second provider;
receiving, from the first provider, at least one first type indicator, at least one first location indicator, at least one first field indicator, at least one first category indicator, and at least one first sub-category indicator, wherein the first type indicator, first location indicator, first field indicator, first category indicator, and first sub-category indicator characterize the first provider;
receiving, from the second provider, at least one second type indicator, at least one second location indicator, at least one second field indicator, at least one second category indicator, and at least second sub-category indicator, wherein the second type indicator, second location indicator, second field indicator, second category indicator, and second sub-category indicator characterize the second provider;
receiving, from the first provider, at least one of a third type indicator, third location indicator, third field indicator, third category indicator, and third sub-category indicator, wherein the at least one of the third category indicator, third location indicator, third field indicator, third category indicator, and third sub-category indicator characterize an envisaged provider different from the first provider;
storing the received first, second, and third type indicators, first, second, and third location indicators, first, second, and third field indicators, first, second, and third category indicators, the first, second, and third sub-category indicators; and
comparing the received second and third type indicators with each other, the received second and third location indicators with each other, the received second and third field indicators with each other, and the received second and third category indicators with each other, and if a match of at least one specific one of the received second and third type indicators, at least one specific one of the received second and third location indicators, at least one specific one of the received second and third field indicators, and at least one specific one of the received second and third category indicators is found, then:
generating a first message indicating the match, and including contact data of the second provider;
sending the first message to the first provider;
generating a second message indicating the match, and including contact data of the first provider;
sending the second message to the second provider; and
storing matching information including the at least one specific one of the received second and third type indicators, the at least one specific one of the received second and third location indicators, the at least one specific one of the received second and third field indicators, and the at least one specific one of the received second and third category indicators.

20. The computer-implemented method of claim 1, wherein the first provider and the second provider are in a medical or pharmaceutical field.

21. The system according to claim 18, wherein the first provider and the second provider are in a medical or pharmaceutical field.

22. The non-volatile data carrier product according to claim 19, wherein the first provider and the second provider are in a medical or pharmaceutical field.
